(19) United States
(12) Patent Application Publication
(10) Pub. No.: US 2024/0110543 A1
(43) Pub. Date: Apr. 4, 2024

(54) WIND TURBINE ROTOR BLADE

(71) Applicant: Siemens Gamesa Renewable Energy A/S, Brande (DK)

(72) Inventors: Lars Oliver Bernhammer, Pamplona (ES); Mads Anker Fremmelev, Aalborg (DK); Purim Ladpli, Bangkok (TH); Esben Orlowitz, Grindsted (DK)

(21) Appl. No.: 18/274,738

(22) PCT Filed: Dec. 14, 2021
(86) PCT No.: PCT/EP2021/085676

§ 371 Date: Jul. 28, 2023

(30) Foreign Application Priority Data
Feb. 9, 2021 (EP) 21155898.6

(51) Int. Cl. F03D 1/06

(52) U.S. Cl. CPC F03D 1/0677; F03D 1/0681; F05B 2220/709

(57) ABSTRACT

A wind turbine rotor blade is provided including a reinforcement element embedded in the body of the rotor blade and extending in a longitudinal direction of the rotor blade; a number of piezo-electric transducers arranged between the leading edge of the rotor blade and the reinforcement element; a number of piezo-electric transducers arranged between the reinforcement element and the trailing edge of the rotor blade; and a connector arrangement configured to apply an excitation signal to any one of the piezo-electric transducers, and to transmit a sensed signal from any one of the piezo-electric transducers to an evaluation module. A wind turbine including a number of such rotor blades and a method of measuring strain in a reinforcement element arranged in such a rotor blade is also provided.

### CROSS-REFERENCE TO RELATED APPLICATIONS

This application claims priority to PCT Application No. PCT/EP2021/085676, having a filing date of Dec. 14, 2021, which claims priority to European Application No. 21155898.6, having a filing date of Feb. 9, 2021, the entire contents both of which are hereby incorporated by reference.

### FIELD OF TECHNOLOGY

The following describes a wind turbine rotor blade; a wind turbine; and a method of measuring loads on a reinforcement element embedded in the body of a wind turbine rotor blade.

### BACKGROUND

Wind turbine rotor blades are generally made primarily from layers of glass-fiber material embedded in a synthetic resin such as epoxy resin or other type of polymer resin. Particularly in the case of longer rotor blades, which must be able to withstand very high loads, it can be beneficial to embed high-stiffness reinforcing components in the laminate structure of the rotor blade body. Carbon-fiber is being used in the manufacture of wind turbine rotor blades because it can impart stiffness to a rotor blade without adding significantly to the overall weight. The inclusion of carbon-fiber structural reinforcing elements leads to a number of further considerations. Since carbon is electrically conductive, any carbon-fiber structural reinforcing element must be included in the lightning protection arrangement, for example be providing an electrical connection between the carbon-fiber structure and a down conductor.

It is known to equip a wind turbine rotor blade with various sensors in order to be able to measure the loads acting on the rotor blade during operation of the wind turbine. Strain gauges can be mounted on a surface of the rotor blade body, or embedded in the composite structure. Thin wires or leads can be used to connect the strain gauges to a transmitter, or directly to an evaluation module. However, it can be difficult to deploy electrical sensors in the vicinity of a carbon reinforcing element, on account of internal sparking or the risk of flash-over, and such electrical sensors would compromise the lightning protection system. A lightning strike could result in damage to data acquisition equipment electrically connected to the sensors. For these reasons, an electrical strain gauge or other electrically conductive sensor may not be placed within a minimum distance—for example 20 cm—of a carbon-fiber reinforcing element or an LPS component. These restrictions greatly limit the number of sensors that can be deployed in a rotor blade with embedded carbon-fiber reinforcements, and any load measurements based on such a limited number of sensors are incomplete and cannot be regarded as reliable indications of actual loads.

However, it is mandatory to be able to monitor or measure mechanical loads, stress, strain etc., as part of load validation and load certification of a wind turbine. Furthermore, it is important to be able to assess the magnitude of the loads acting on the rotor blade and its embedded structures during operation of the wind turbine, so that a wind turbine controller can adjust the operating references if necessary, in order to avoid damage.

To overcome these problems, it has been proposed to implement optical strain gauges that do not include any conductive parts. However, it is very costly to implement such optical strain gauges at reinforcing structures such as carbon-fiber spar caps, since it is difficult to place the optical strain gauges between the spar cap and the shear web or beam, and the spar cap cannot be accessed directly from the inside of the rotor blade. It is generally also not practicable to arrange such optical strain gauges at the outside surface of the rotor blade, because they are relatively large and would alter the aerodynamic profile of the rotor blade, and because any such externally attached body may eventually detach and fail. In another approach, fiber-optic strain gauges may be deployed, by gluing optical fibers onto the external surface of a rotor blade and manually over-laminating these. Such a solution has been shown to lack robustness and to deliver erroneous measurements.

### SUMMARY

An aspect relates to an improved way of measuring loads in a rotor blade with an embedded carbon-fiber reinforcing structure.

According to the invention, the wind turbine rotor blade comprises a reinforcement element embedded in the body of the rotor blade and extending in a longitudinal (i.e., span-wise) direction of the rotor blade, so that one “long” side of the reinforcement element is essentially aligned relative to the leading edge of the rotor blade and its other “long” side is essentially aligned relative to the trailing edge of the rotor blade. A longitudinal axis of the reinforcement element may be aligned more or less along the longitudinal axis of the rotor blade in the usual manner. The inventive rotor blade further comprises a plurality of piezo-electric transducers on either side of a reinforcement element, with a number of piezo-electric transducers arranged at a distance removed from one long side of the reinforcement element, and also a number of piezo-electric transducers arranged at a distance removed from the other long side of the reinforcement element. One set of piezo-electric transducers is therefore closer to the leading edge, and the other set is closer to the trailing edge of the rotor blade. Each piezo-electric transducer is configured to convert an electrical excitation signal into mechanical vibration, and to convert mechanical vibration into an electrical signal or “sensed signal”. The inventive rotor blade further comprises a connector arrangement, e.g., a set of wires or leads, for applying an excitation signal to any one of the piezo-electric transducers, and for relaying a sensed signal from a piezo-electric transducer to an evaluation module.

In the context of embodiments of the invention, a piezo-electric transducer shall be understood to respond to an excitation voltage by vibration. The amplitude and frequency of vibration is directly related to the amplitude and frequency of the excitation signal. Equally, such a piezo-electric transducer shall be understood to respond to vibration by generating a corresponding voltage or “sensed signal”. The skilled person will be familiar with the principle of operation of such piezo-electric devices. The amplitude and frequency of the vibration generated in response to an electrical excitation signal essentially “mirror” the amplitude and frequency of the voltage applied to the transducer. Similarly, the amplitude and frequency of the voltage generated by a sensing transducer essentially “mirror” the amplitude and frequency of the sensed vibrations. In the following, therefore, the same terms may be used to refer to an excitation voltage and the resulting vibration, or to a sensed vibration and the resulting voltage.

An advantage of the inventive rotor blade is that the load acting on a reinforcement element embedded in the rotor blade can be estimated reliably during operation of the wind turbine. This information can then be used to adjust the wind turbine operating parameters in order to avoid over-loading the reinforcement element (or the rotor blade). As the skilled person will be aware, structural elements of a rotor blade are manufactured to withstand loads up to a certain magnitude. The information obtained from signals sensed by the piezo-electric transducers can also be used to adjust the wind turbine operating parameters in order to increase output power if it can be established that the reinforcement elements are under-loaded.

According to embodiments of the invention, the wind turbine comprises a number of such rotor blades mounted to a hub; an excitation module configured to apply an excitation signal to any one of the piezo-electric transducers; and an evaluation module configured to evaluate a signal received from a piezo-electric transducer.

According to embodiments of the invention, the method of evaluating the structural integrity of a reinforcement element embedded in the body of a rotor blade of such a wind turbine comprises the steps of selecting a piezo-electric transducer on one side of a reinforcement element, operating the excitation module to apply an excitation signal to the selected transmitter; and operating the evaluation module to evaluate a signal received by a piezo-electric transducer on the other side of the reinforcement element.

Embodiments and features of the invention are given by the dependent claims, as revealed in the following description. Features of different claim categories may be combined as appropriate to give further embodiments not described herein.

In the following, without restricting embodiments of the invention in any way, it may be assumed that a reinforcement element is a spar cap arranged at an outer end of the shear web of a spar. Generally, the shear web is arranged essentially perpendicular to the chord, and a spar cap is arranged in a transverse direction relative to the shear web.

A reinforcement element may have a laminar structure, i.e., it may comprise layers of reinforcing material bonded by resin. An exemplary reinforcing element may be made of pultruded carbon-fiber elements, bonded together to form a long and essentially flat structure that can be embedded in the rotor blade body, for example by mounting at either end of the shear web of a spar. In the following, without restricting embodiments of the invention in any way, it may be assumed that the reinforcement element comprises carbon-fiber material.

The terms “carbon-fiber spar cap”, “carbon spar cap” or simply “spar cap” may be used interchangeably in the following. Unless otherwise indicated, it shall be assumed that the term “spar cap” refers to a spar cap made of carbon-fiber reinforced material, for example stacks of pultruded carbon-fiber layers bonded by resin. Such a pre-fabricated carbon spar cap is generally arranged in the desired position between layers of glass-fiber matting during the composite layup step when molding a rotor blade, as will be known to the skilled person.

As explained above, the piezo-electric transducers are of the type that convert between an electrical signal and mechanical vibration, i.e., a piezo-electric transducer converts an electrical signal into mechanical vibration and vice versa. The expressions “sensed signal” and “received signal” shall be understood to be synonyms and may be used interchangeably herein. As the skilled person will be aware, various suitable types of piezo-electric transducers could be used. For example, piezoelectric ceramic elements such as piezoelectric discs, plates, rings, or cylinders can be used. Discs with a diameter in the order of 5-25 mm and a thickness in the order of 0.2-3 mm may be deployed. Such devices may be mounted onto a surface of the rotor blade. Equally, such devices may be embedded with relative ease in the composite layer structure of a rotor blade body. Embodiments of the invention can be realized using stacked piezoelectric actuators, for example to generate a suitably strong acoustic vibration if design constraints require that opposing pairs of transducers must be placed relatively far apart. A “piezo-electric transducer” may be referred to simply as “transducer” in the following.

In an embodiment of the invention, the rotor blade comprises a plurality of piezo-electric transducers in linear arrangements or “strings” on either side of a carbon spar cap. Each pair of opposing transducers can be arranged “in line”, i.e., along a line that is essentially perpendicular to the long axis of the spar cap. Each linear arrangement of piezo-electric transducers is connected by an electrical conductor to an excitation module and/or to an evaluation module. For example, the piezo-electric transducers on one side of a carbon spar can be used only as “transmitters” (i.e., to generate vibration in response to an excitation voltage), and the piezo-electric transducers on the other side of that carbon spar are used only as “receivers” or “sensors” (i.e., to generate a voltage in response to a sensed vibration). Alternatively, the piezo-electric transducers on either side of a carbon spar can be used alternately as “transmitters” and as “sensors”, by connecting the piezo-electric transducers in an appropriate manner to both excitation module and evaluation module.

The excitation signal can be of any suitable nature. In an embodiment of the invention, the excitation signal is a burst, for example a brief sequence of oscillations in a well-defined envelope.

In an embodiment of the invention, the evaluation module is configured to compute the time-of-flight between an excitation signal and a received signal. This can be done by identifying a landmark peak in the received signal that corresponds to an equivalent landmark peak of the excitation signal.

In an embodiment of the invention, the evaluation module is configured to compute the attenuation of the received signal relative to the excitation signal.

Of course, as other—more complex—signal parameters can be extracted using appropriate signal processing techniques such as wavelet transform, Hilbert transform, matching pursuit signal decomposition, etc.

In an embodiment of the invention, the excitation signal is a continuous signal such as a sinusoidal signal. Such an approach may be desired if the spar cap strain can be reliably estimated from signal attenuation.

Evaluation of a sensed signal can be performed by comparing the sensed signal to an expected signal. This can be done on the basis of previously collected calibration data, for example. It is known to subject a rotor blade of a particular type to cyclic load tests in order to estimate the expected lifetime of the rotor blade, to determine maximum allowable loads, to measure deflection under load, etc. Such a load testing procedure can also be used to collect relevant information for the inventive method. In one approach, transducers are selectively actuated while the rotor blade is in a non-loaded state, and sensed signals are collected. Subsequently, the rotor blade is subject to a known load, and sensed signals are again collected. Since the load is known, it is possible to establish the spar cap strain, and a relationship can be established between strain and the observed sensed signal. Later, during operation of a wind turbine, it is straightforward to evaluate a sensed signal to estimate the momentary strain in the corresponding spar cap.

To actuate the transducers and evaluate the sensed signals, a wind turbine is equipped with a suitable control unit, which can for example be installed in the hub. The control unit includes an excitation module for applying an excitation signal to one or more transducers. This can be done at regular intervals during operation of the wind turbine, or in response to a command from a controller, for example. The control unit may also comprise an evaluation module for receiving and processing the resulting sensed signals. Of course, the evaluation module need not be realized “locally”. Instead, the control unit may be configured to forward any sensed signals to a remote park controller, for example, for evaluation and processing. Either way, the results of evaluation and processing of the sensed signals can be used to adjust control references of the wind turbine, for example to increase power output if the rotor blades are not excessively loaded, or to decrease power output or adjust the rotor blade pitch if the rotor blade is experiencing unfavorably high loads.

In one embodiment of the inventive rotor blade, the reinforcing elements are spar caps on either side of the shear web of a spar in a region of maximum airfoil thickness of the rotor blade. A linear arrangement of piezo-electric transducers is arranged on either side of the spar cap at the suction side of the rotor blade, and another linear arrangement of piezo-electric transducers is arranged on either side of the spar cap at the pressure side of the rotor blade. In such an embodiment, a total of four strings of piezo-electric transducers is embedded in the rotor blade.

In an embodiment of the inventive rotor blade, in addition to the carbon spar caps in the region of maximum airfoil thickness as explained above, the rotor blade also includes a smaller spar closer to the trailing edge, and the spar caps of this smaller spar can also be reinforcement elements in the context of embodiments of the invention. It shall be appreciated that such a “trailing edge spar” and its spar caps may be smaller than the main spar and its spar caps. In such an embodiment, a total of eight strings of piezo-electric transducers may be embedded in the rotor blade, with two strings of transducers on either side of each spar cap. In an embodiment of the invention, the number of piezo-electric transducers can be reduced by arranging a single string between a spar cap of the main spar and a spar cap of the trailing edge spar on the suction side, and by arranging a single string between the spar cap of the main spar and the spar cap of the trailing edge spar on the pressure side. In such an embodiment, a total of six piezo-electric transducer strings is sufficient to estimate the strain on four carbon spar caps.

Of course, the reinforcement element does not need to be a spar cap, and can simply be a laminar reinforcing structure embedded in any region of the rotor blade. Embodiments of the invention are particularly advantageous when applied to a reinforcement element that is inherently conductive as explained above, since the transducers are positioned at a safe distance and do not pose a risk from flashover during a lightning event.

The inventive method allows strain or load on a reinforcement structure to be measured indirectly, i.e., without the need to place a sensor directly on the reinforcement structure itself. This makes embodiments of the invention particularly suitable for measuring strain and load in hard-to-reach or inaccessible regions of rotor blade, for example in or close to the trailing edge, or in the thin tip end of the rotor blade.

### BRIEF DESCRIPTION

Some of the embodiments will be described in detail, with reference to the following figures, wherein like designations denote like members, wherein:

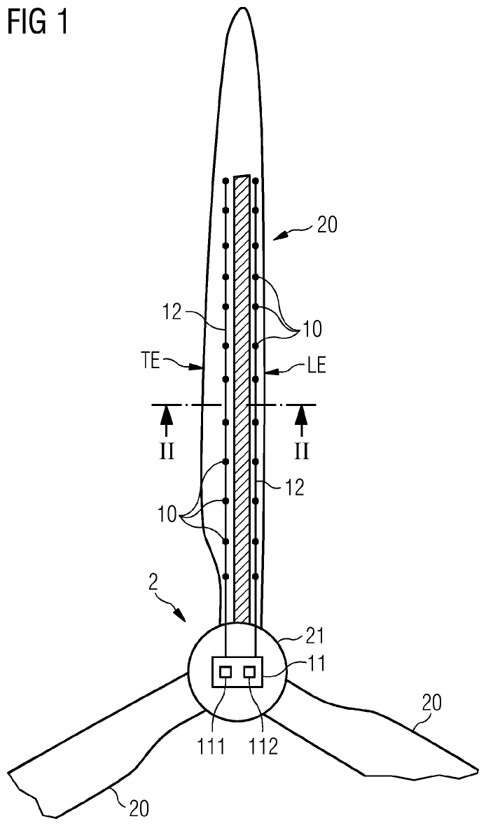

FIG. 1 shows a wind turbine equipped with rotor blades according to an embodiment of the invention;

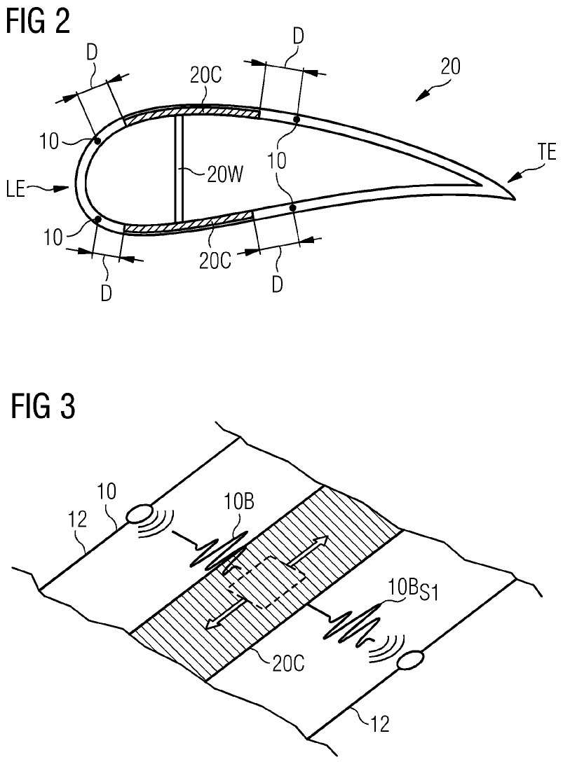

FIG. 2 shows a cross-section through a rotor blade according to an embodiment of the invention;

FIG. 3 illustrates a stage in the inventive method;

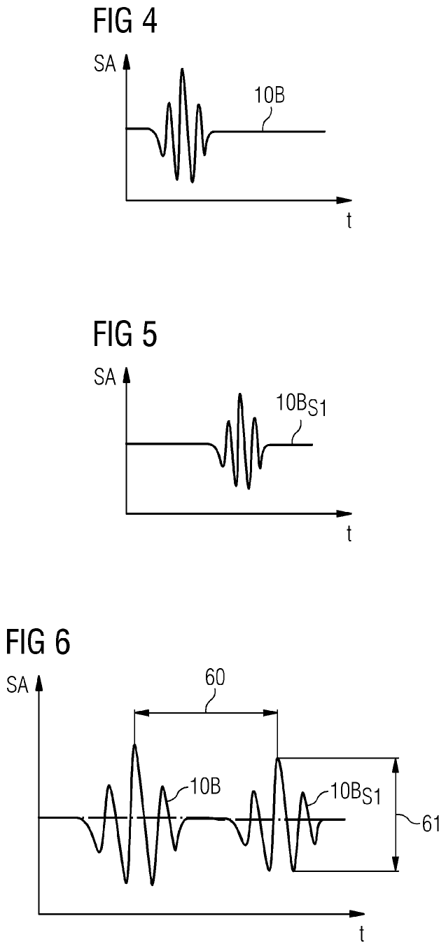

FIG. 4 shows exemplary signals in one implementation of the inventive method;

FIG. 5 shows exemplary signals in one implementation of the inventive method;

FIG. 6 shows exemplary signals in one implementation of the inventive method;

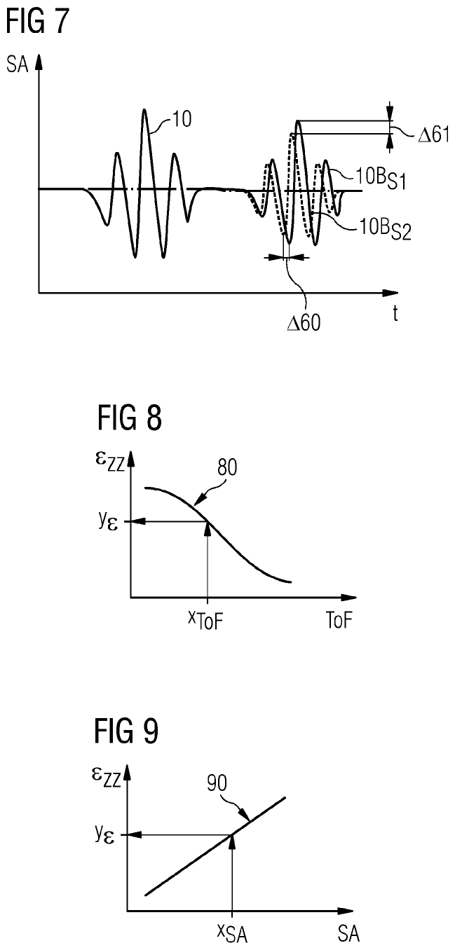

FIG. 7 shows exemplary signals in one implementation of the inventive method;

FIG. 8 illustrates a further stage in the inventive method;

FIG. 9 illustrates a further stage in the inventive method;

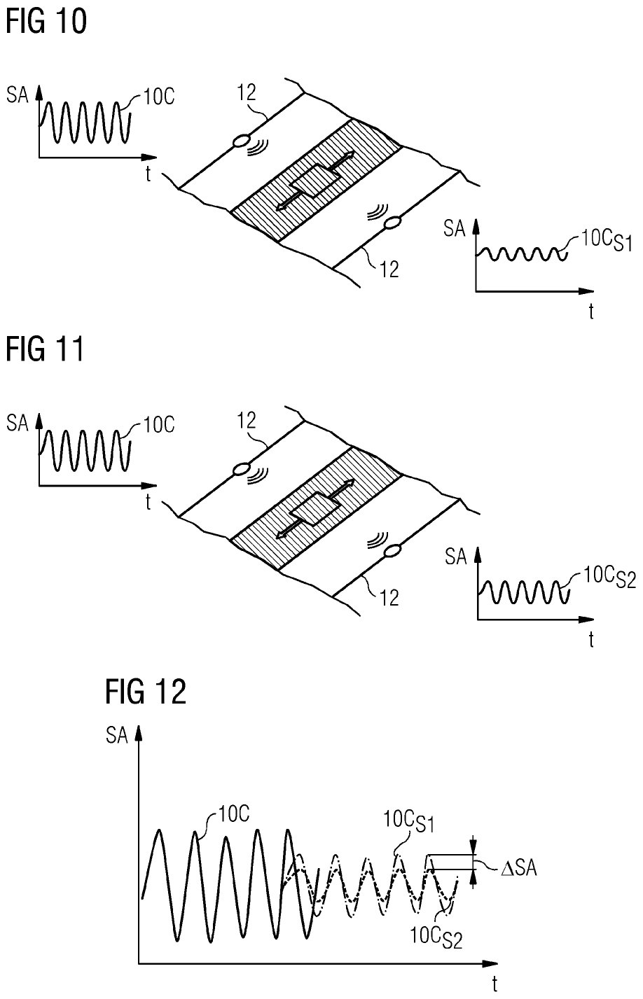

FIG. 10 illustrates a further implementation of the inventive method;

FIG. 11 illustrates a further implementation of the inventive method;

FIG. 12 illustrates a further implementation of the inventive method; and

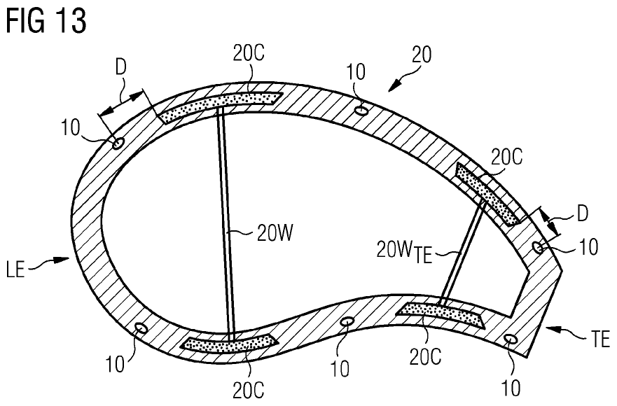

FIG. 13 shows a cross-section through a rotor blade according to a further embodiment of the invention.

### DETAILED DESCRIPTION

FIG. 1 is a schematic drawing showing relevant parts of a wind turbine 2 equipped with rotor blades 20 according to an embodiment of the invention. The diagram shows one of three rotor blades 20 mounted to a hub 21. Each rotor blade 20 incorporates a reinforcing structure 20C made of carbon-fiber, embedded in the body of the rotor blade 20. This is illustrated in FIG. 2, which shows a cross-section II-II′ through the rotor blade 20 of FIG. 1 and indicates a carbon-fiber reinforcing structure 20C as a spar cap on either end of the shear web 20W of a spar. The carbon-fiber reinforcing structures 20C are referred to as “spar caps”, and the spar (shear web and spar caps) serves to increase the structural strength of the rotor blade 20.

In this exemplary embodiment, piezo-electric transducers 10 are embedded in the body of the rotor blade 20, in an essentially linear arrangement, along each side of the spar cap 20C as shown in FIG. 1. Each transducer 10 is located at a distance D from the conductive carbon-fiber spar cap 20, as indicated in FIG. 2, in order to comply with an electrical safety requirement as explained in the introduction. The distance D between transducer 10 and spar cap 20C is not necessarily the same for each transducer 10, it is only important that this distance D is at least as large as the minimum distance defined by appropriate regulations or requirements. The transducers 10 are connected by wires to a control unit 11. The wires can be embedded in the rotor blade body, or may be arranged along a surface in the interior of the rotor blade. In an alternative embodiment, the piezo-electric transducers 10 could be mounted on a surface of the rotor blade 20.

FIG. 1 also shows a control unit 11 installed in the hub 21, and includes an excitation module 111 for applying an excitation signal to one or more transducers 10, and also an evaluation module 112 for receiving and processing the resulting sensed signals. Of course, the evaluation module 112 need not be realized “locally” as shown here. Instead, the control unit 11 may be configured to forward any sensed signals to a remote location for evaluation and processing. As explained above, the results of evaluation and processing of the sensed signals can be used to adjust control references of the wind turbine, so that output power can be maximized while avoiding excessive loading on the rotor blades.

FIG. 3 illustrates a stage in the inventive method. The diagram shows a pair of transducers 10 on either side of a spar cap 20C. Each transducer 10 can transmit and receive, so that any transducer 10 can be actuated to vibrate when it receives an electrical excitation signal; and each transducer 10 can generate an electrical signal in response to excitation through vibration. The diagram illustrates this effect, indicating vibrations 10B propagating through the spar cap 20 as a result of excitation of the transducer 10 on the left (the “transmitting” transducer) by a burst signal; and the attenuated/distorted vibrations which will be received by the transducer 10 on the right (the “receiving” or “sensing” transducer). Embodiments of the invention make use of the fact that the spar cap 20C is embedded between layers of composite fiberglass material, and that the boundaries between layers of the laminate structures effectively “guide” the vibrations from the excitation transducer to the spar cap, and from the spar cap to the sensing transducer. The spar cap 20C may also have an essentially laminate structure.

The identity of each transducer 10 can be configured by appropriate logic, as will be known to the skilled person, so that the excitation unit 111 can issue a burst excitation signal 10B (or any other suitable excitation signal) to a specific “transmitting” transducer 10 by enabling that transducer. Similarly, the evaluation unit 112 can enable a specific “receiving” transducer(s) from which to receive a signal generated in response to a sensed vibration burst 10B_{S1}. The extent of attenuation and distortion of the received signal will depend on various parameters such as the distance travelled, the width of the spar cap 20, the density of the materials in the signal path, etc. Such parameters remain essentially constant for any pair of transducers. However, during operation of the wind turbine, loads acting on the rotor blade 20 will result in stress/strain in the spar cap 20C, which in turn contributes to the attenuation and distortion of the signal 10B_{S1} arriving at the receiving transducer. For a spar cap, strain in the Z-direction (i.e., in the longitudinal span-wise direction) is of primary interest, because the spar caps are most affected by span-wise loading on the rotor blade. The diagram illustrates an exemplary rectangular region (indicated by the dashed line) in the spar cap 20C and the direction of strain E through compression or extension when the rotor blade undergoes span-wise deflection as a result of wind loading.

Signal distortion by the presence of the spar cap 20C is illustrated with the aid of FIGS. 4-7, which show signal amplitude SA (e.g., in Volts) against time t (e.g., in milliseconds). An exemplary excitation signal 10B in the form of a burst is shown in FIG. 4. FIG. 5 shows an attenuated and distorted version as signal 10B_{S1}. FIG. 6 shows both signals 10B, 10B_{S1} in the same time frame to illustrate the time-of-flight 60 or delay 60 between the transmitted signal 10B and the received signal 10B_{S1}, and the largest amplitude 61 of the received signal 10B_{S1}. The attenuated signal 10B_{S1} shown in FIG. 5 may be measured for a non-loaded rotor blade, i.e., the spar cap 20C is not under any strain from loading. FIG. 6 then shows a comparison between the excitation signal 10B and the received signal 10B_{S1} without any loading strain. Such measurements can be made for each transducer pair for multiple different loading situations during a calibration stage. Such measurements can be made for all new rotor blades of the same series and compared against benchmark measurements, as a part of quality control. FIG. 7 illustrates a situation during loading of the rotor blade. The diagram shows the excitation signal 10B, the “non-loaded” received signal 10B_{S1}, and a received signal 10B_{S2} obtained at the same transducer during a state in which the spar cap is under load. Depending on how the rotor blade is being loaded, span-wise deflection or bending of the rotor blade will result in stretching or compression of the spar cap 20C, and this in turn will affect the passage of the excitation signal. Therefore, the time of flight is different for the received signals 10B_{S1}, 10B_{S2}, and the time-of-flight difference Δ60 can be used to infer information about the loads acting on the spar cap, for example it is possible to infer the magnitude of the momentary load. Similarly, the peak-to-peak amplitude is different for both received signals 10B_{S1}, 10B_{S2}, and the difference Δ61 can also be used to infer information about the loads acting on the spar cap.

Such information can be collected for a wide range of loads, for example in a calibration setup which allows a rotor blade to be subject to known loads. The results can be collected and evaluated so that during operation of the wind turbine, a time-of-flight measurement or an amplitude measurement can be used to infer the momentary strain on the spar cap. This is illustrated in FIGS. 8 and 9, which show strain curves 80, 90. A first strain curve 80 is obtained by developing a relationship between Z-direction strain ε_{ZZ} and time-of flight ToF, allowing strain ε to be expressed as a function of time-of flight:

ε_{ZZ}=f₁(ToF) (1)

A second strain curve 90 is obtained by developing a relationship between Z-direction strain ε_{ZZ} and signal amplitude SA, allowing Z-direction strain ε_{ZZ} to be deduced from the amount of attenuation:

ε_{ZZ}=f₂(SA) (2)

With such relationships established during a calibration procedure, or from data collected from various rotor blades over many hours of operation under known loading conditions, it is possible to relate a measured time-of-flight value x_{ToF} or a measured attenuation value x_{SA} to a specific strain value y_{ε}.

FIGS. 10-12 illustrate a further implementation of the inventive method. Here, instead of the burst signal discussed above, the excitation signal 10C can be continuous, for example a continuous sine wave. With this approach, only signal attenuation need be measured, and two exemplary received signals 10C_{S1}, 10C_{S2} are shown for different strain conditions, for example signal 10C_{S1} may be received during a non-loaded state of the rotor blade as indicated in FIG. 10, and signal 10C_{S2} may be received during a loaded state of the rotor blade as indicated in FIG. 11. FIG. 12 shows an exemplary graph showing the excitation signal 10C and the received signals 10C_{S1}, 10C_{S2}. The difference in peak-to-peak amplitude ΔSA can be used to infer the strain of the spar cap in FIG. 11 from a relationship established during a calibration stage, similar to the method explained with the aid of FIGS. 4 to 7 above, allowing the load magnitude to be estimated.

FIG. 13 shows a cross-section through a rotor blade 20 according to a further embodiment of the invention. In this exemplary embodiment, the rotor blade 20 is equipped with additional spar caps 20C at either end of a shear web 20W_{TE} closer to the trailing edge TE of the rotor blade 20. To be able to measure the deformation of both sets of spar caps 20C when the rotor blade 20 is under load, three rows of piezo-electric transducers 10 are deployed—in essentially the same manner shown in FIG. 1—so that each spar cap 20C is between two rows of transducers 10. To estimate loads on a spar cap 20C, the “middle” transducer 10 can be actuated by an excitation signal as explained above, and the transducer on the other side of that spar cap 20C will sense the vibration and generate an electrical signal in response.

Although the present invention has been disclosed in the form of embodiments and variations thereon, it will be understood that numerous additional modifications and variations could be made thereto without departing from the scope of the invention. For example, the inventive method can be carried out as part of a structural health monitoring (SHM) procedure, by storing data collected during the lifetime of the rotor blade and by evaluating measured signals obtained under similar operating conditions. Structural deterioration of a rotor blade may be identified from unexpected measurements at known operating conditions, for example.

For the sake of clarity, it is to be understood that the use of “a” or “an” throughout this application does not exclude a plurality, and “comprising” does not exclude other steps or elements.

1-15. (canceled)

16. A wind turbine rotor blade comprising:
a reinforcement element embedded in the body of the rotor blade and extending in a longitudinal direction of the rotor blade;
a plurality of piezo-electric transducers on either side of the reinforcement element, with a number of piezo-electric transducers arranged between the leading edge of the rotor blade and the reinforcement element and a number of piezo-electric transducers arranged between the reinforcement element and the trailing edge of the rotor blade;
wherein a piezo-electric transducer is configured to convert an electrical excitation signal into mechanical vibration and to convert mechanical vibration into a sensed signal; and a connector arrangement configured to apply an excitation signal to any one of the piezo-electric transducers on one side of the reinforcement element, and to transmit a sensed signal from any one of the piezo-electric transducers on the other side of the reinforcement element to an evaluation module.

17. The rotor blade according to claim 16, wherein a piezo-electric transducer further comprising a disc with a diameter in the order of 5-25 mm and a thickness in the order of 0.2-3 mm.

18. The rotor blade according to claim 16, wherein the reinforcement element is realized as a spar cap of a spar.

19. The rotor blade according to claim 16, wherein each pair of opposing piezo-electric transducers is arranged along a line that is essentially perpendicular to the long axis of the reinforcement element.

20. The rotor blade according to claim 16, wherein a reinforcement element is arranged in a region of maximum airfoil thickness of the rotor blade.

21. The rotor blade according to claim 16, wherein a reinforcement element further comprising a laminate structure.

22. The rotor blade according to claim 16, wherein the reinforcement element is made of carbon-fiber.

23. A wind turbine comprising:
a number of rotor blades according to claim 16 mounted to a hub;
an excitation module configured to apply an excitation signal to any one of the piezo-electric transducers; and
an evaluation module configured to evaluate a signal received from a piezo-electric transducer.

24. The wind turbine according to claim 23, wherein the evaluation module is configured to compute the time-of-flight between an excitation signal and a received signal.

25. The wind turbine according to claim 23, wherein the evaluation module is configured to compute the attenuation of a received signal relative to the excitation signal.

26. A method of measuring strain in a reinforcement element of a rotor blade of a wind turbine according to claim 23, which method comprises:
selecting a piezo-electric transducer on one side of a reinforcement element of the rotor blade;
operating the excitation module to apply an excitation signal to the selected transducer;
operating the evaluation module to evaluate a signal received by a piezo-electric transducer on the other side of the reinforcement element to infer the magnitude of strain in the reinforcement element.

27. The method according to claim 26, wherein the excitation signal is any of a tone burst, a continuous sinusoidal signal, a white noise signal, a chirp signal.

28. The method according to claim 26, further comprising a step of evaluating sensed signals under multiple known loading states of the rotor blade in a calibration procedure.

29. The method according to claim 26, further comprising a step of comparing evaluation results obtained during operation of the wind turbine to evaluation results recorded during the calibration procedure.

30. The method according to claim 26, further comprising a step of assessing the structural health of a rotor blade from a comparison of evaluation results obtained during the lifetime of the rotor blade.
